(19) United States
(12) Patent Application Publication
(10) Pub. No.: US 2021/0192592 A1
(43) Pub. Date: Jun. 24, 2021

(54) Indoor Localization Enabled Shopping Assistance in Retail Stores

(71) Applicant: BlooLoc NV, Hasselt (BE)

(72) Inventors: Dirk Callaerts, Schulen (BE); Koen Deforche, Kessel-Lo (BE); Els Deneyer, Hasselt (BE); Wim Dumon, Hofstade (BE)

(21) Appl. No.: 16/076,059

(22) PCT Filed: Feb. 8, 2017
(86) PCT No.: PCT/EP2017/052731

§ 371 Date: Aug. 7, 2018

(30) Foreign Application Priority Data
Feb. 8, 2016 (EP) 16154602.3

(51) Int. Cl. G06Q 30/06; G06Q 10/06; G06K 19/07; G06K 7/10; G06Q 30/02; H04W 4/029; H04W 4/024

(52) U.S. Cl. CPC G06Q 30/0619; G06Q 10/063114; G06K 19/0723; G06K 7/10297; H04W 4/80; G06Q 30/0635; H04W 4/029; H04W 4/024; G06Q 30/0255

(57) ABSTRACT

The present invention concerns methods, systems and devices that use indoor localization for assisting customers in retail stores. The customer is provided with a tag for localizing said customer while he or she moves through the store. The sales person is provided with a mobile device for localizing said sales person and for notification. The customer can request for assistance, in which case a sales person is allocated to the customer by the shopping assistance system. The sales person can start assisting the customer after an interaction between the mobile device and the tag, preferably on the basis of a proximity determination between the mobile device of the sales person and the tag of the customer.

### TECHNICAL FIELD

The present invention relates to a method, a system and devices for assisting individual customers in a retail store environment. More particularly, the described embodiments relate to a method for assisting customers in a store, thereby ensuring that the customer is assisted as soon as possible, in the order corresponding to the customer's ranking, preferably using a server, one or more tag devices and mobile devices for localization of customers and sales persons, as well as for interaction between a customer and a sales person.

### BACKGROUND

A positive shopping experience is, and increasingly will become a key differentiator for retail stores. Shopping assistance is an important element of the shopping experience. Customers expect assistance that is unobtrusive (obtrusive sales persons are regarded as irritating shopping experiences), timely (customers hate waiting), correctly prioritized (customers that jump ahead is a source of irritation), expert (customers expect the sales person to know more about the products than he or she can find on the Internet) assistance.

Complicating shopping assistance is that many products sold in retail environments have become increasingly sophisticated and complex. Moreover, retailers face fierce pricing pressures, forcing them to increase operational efficiencies and cut costs. Due to these pricing pressures, retailers often have a difficult time providing quality product information and sales support in their stores. Additionally, retailers have no way of identifying their prime customers when they walk through the door and no way to unobtrusively connect to customers for an improved shopping experience. The poor shopping experience can reduce customer spending, raise product dissatisfaction, and motivate customer defection.

From a customer's perspective common issues include: 1) the customer is waiting and unable to get the attention or service when he or she needs it; 2) the customer gets attention when he or she does not want it; 3) another customer gets attention although he or she is not next in line; 4) the customer is assisted by a sales person that is not knowledgeable regarding the product(s) the customer wants; and 5) the customer needs to wait at the payment desk, while he or she would prefer spending that time enjoying the products on display. From the retailer's perspective, common issues include: 1) how to keep the sales force small and nimble without compromising on the quality of customer assistance; 2) how to identify and engage with the retailer's most valued customers without obtrusive and inefficient sales approaches; and 3) how to avoid lost opportunities due to the lack of high quality shopping experience.

It is the aim of the present invention to provide a method, a system and devices wherein at least some of the above identified problems are solved in a technical way.

### SUMMARY OF THE INVENTION

Methods, systems and devices that use indoor localization for assisting customers in retail stores are described.

The present invention provides a method for assisting customers, comprising the steps of:

(a) providing a customer with a tag for localizing said customer;
(b) obtaining localization information about said tag while said customer moves through the store;
(c) attributing a ranking to a customer, if a request for assistance is received from said customer, whereby said ranking is indicative of the priority of the customer in the group of customers requesting assistance, preferably said request being given via said tag;
(d) providing a customer with assistance information such as his ranking, the number of customers in queue and/or the estimated waiting time, preferably said information being visualized either via an indicator on said tag, via a display on said tag, or via a display in the store;
(e) obtaining localization information about a sales person via a mobile device of said sales person;
(f) if said customer is entitled to assistance based on said ranking and if said sales person is available for lending assistance, allocating said sales person to said customer;
(g) notifying said sales person via his mobile device that a customer needs assistance and providing information about the location of said customer in the store to said sales person via his mobile device;
(h) obtaining information that the sales person has started assisting the customer, characterized in that said information is obtained on the basis of an interaction between the mobile device and the tag, preferably on the basis of a proximity determination between the mobile device of the sales person and the tag of the customer, and
(i) obtaining information that the sales person has ended assisting the customer.

The method includes a first step of providing the customer with a tag, allowing the customer to be localized while he or she is shopping within the confines of the store. The tag can be a tangible, relatively cheap device which can be picked up at kiosks that are strategically distributed over the store. Hereby, picking up the tag and/or moving through the store could be deemed as a means to signal a request for assistance. Alternatively, the tag can be provided with a signaling means, e.g. a button, whereby upon using the signaling means, a request is sent from the tag to a central server for further processing. The signaling means allows the customer to choose whether he requests for assistance immediately upon entering the store or only after having walked through the store (and e.g. seeing something that he needs assistance for), hence enabling a better overall customer experience. Still alternatively, the tag could consist of an application (“app”) installed on a mobile device of the customer, where the device should be equipped with means for localization, transmitting data and signaling, e.g. a smartphone. Hereby the app can be manually or automatically started, e.g. upon entering the store and e.g. via a Bluetooth interface. When the app is started, the mobile device is configured to provide a similar functionality as a tangible tag which can be picked up at the store. Still alternatively, the tag could consist of a mobile device provided by the store, where this device should equally be equipped with means for localization, transmitting data and signaling, e.g. a tablet or iPod Touch configured to provide the functionality of a tag.

The tag allows the customer to be localized within the store. A number of localization methods and systems are known. Preferably, a real-time location system (RTLS) is used. This can preferably be achieved by a number of beacons distributed in and/or around the store, configured to pick up a signal transmitted by the tag, preferably a Bluetooth signal, whereby said signal preferably comprises data identifying the tag and/or the customer. The beacons can interact with a central server, which receives the localization data of the tag from the beacons and is configured to compute the position of the tag and/or customer in the store. Alternatively or additionally, in case the tag is a mobile device (either belonging to the customer or provided by the store), each of the beacons transmits a beacon signal comprising data identifying the beacon, and the mobile device is configured to receive said beacon signals. Said mobile device then preferably interacts with a central server, which receives the localization data of the beacons from said mobile device and is configured to compute the position of said mobile device and/or customer in the store.

The request for assistance can be automatic, i.e. the request can be triggered automatically e.g. by picking up a tag or activating the app on the mobile device belonging to the customer or provided by the store. Alternatively, the request for assistance can be done manually or semi-automatically, such as by pressing a button or touch area with button functionality on the tag. The request may comprise surplus information indicative of the nature of the requested assistance, such as whether the assistance relates to general information, or information about a specified article. In a preferred embodiment the customer can enter additional info regarding the request for assistance at a kiosk's terminal if said tag is a tangible electronic device. In another preferred embodiment the customer can enter said additional info via the interface of the mobile device if said tag is a mobile device.

Once a customer has sent a request for assistance, a ranking is attributed to the customer and/or tag. This ranking can be based solely on the time of the request on a first-come first-served basis. Alternatively, other factors are taken into account such as the nature of the request and/or previous shopping behavior of the customer. Optionally, the customer is also provided with assistance information such as (an indication of) the ranking, the number of customers in queue and/or the estimated waiting time, as well as advertising that may be related to data retrieved from the previous shopping experience of the customer. In case the tag is a tangible device, said assistance information can be visualized via an indicator, e.g. one or more LEDs, or a small display, whereas said advertising can be visualized on a display if present. In case the tag is a mobile device, said assistance information and advertising can be visualized via the screen. Alternatively, said assistance information may be visualized via displays in the store and this preferably in an anonymous way, by visualizing a code or number on the displays in the store matching the code or number visualized on the tag of the customer.

Hence, after requesting assistance, the customer can proceed into the store and enjoy shopping, while being assured that he or she is next in line to be assisted.

A shopping assistance system, typically comprising a central server, collects all requests for assistance and allocates them to the most appropriate sales person. This can be done using pre-determined scheduling rules. The sales person is notified via a mobile device by the shopping assistance system, and is informed of which customer needs assistance next and the position of the customer within the shop, optionally accompanied by any relevant information regarding the customer and his or her request. The sales person can then use an indoor navigation app on the mobile device to locate the customer and to navigate to the customer via the shortest route. Upon reaching the customer, the sales person may optionally collect the tag to then assist the customer, whereby the shopping assistance system can be notified that the assistance has started e.g. by holding the tag close to the mobile device. After assisting the customer, the sales person can use the mobile device to notify the system that the assistance has been completed and that he is available for further customer assistance.

The start of the assistance can be triggered by an interaction between the mobile device and the tag, consisting in determining a relative distance between the mobile device and the tag, and comparing said relative distance with a predefined maximum distance to determine that the mobile device and tag are in close proximity. In a preferred embodiment proximity is determined by means of near field communication (NFC) between tag and mobile device. This choice may be motivated by large battery life for one of both devices involved in the communication (either tag or mobile device), since NFC allows communication between a device with an active interface (using battery power) and a passive interface (not using any battery power). Another motivation to use NFC is the high robustness; with a working distance of typically less than 20 cm, NFC is particularly well suited for crowded areas with many customers (and tags), that complicate associating a signal with the intended user tag.

In a further preferred embodiment, a profile can be attributed to a tag provided to the customer, said profile comprising information on the customer such as personal interests and previous shopping orders. This profile information may be taken into account when attributing a ranking to the customer.

In a further preferred embodiment where it is assumed that the sales person does not collect the tag when reaching the customer, the shopping assistance system may be programmed to notify the customer via his or her tag when his or her order is ready at the payment desk. This may be a basic notification stating that the order is ready, but it may as well include further assistance information, such as an indication of the current queue length at the payment desk and/or the current estimated waiting time at the payment desk.

In a further preferred embodiment, the shopping assistance system detects when a customer tag goes beyond the confines of the store e.g. when leaving through the exit, in which case the customer (via his or her tag) and/or one or more sales persons are notified of this event. In this way, customers are reminded to return their tag at the store exit.

In a further preferred embodiment, the shopping assistance system stores data related to the movement of the customer through the store. The retailer may analyze this data for marketing purposes and retail optimization.

In a further preferred embodiment, the shopping assistance system stores data related to the movement of and the assistance provided by the sales person. The retailer may analyze this data for sales force optimization and incentivizing.

### DETAILED DESCRIPTION

The present invention relates to shopping assistance via indoor localization and communication systems and methods including a combination of automated and human services to be provided to a customer in a retail store environment in real time. Getting properly served is quite challenging for customers and maintaining a high quality customer experience is equally challenging for retailers, due to fiercely competitive pricing and constantly changing environments.

Embodiments of the present invention provide customers with timely and unobtrusive live assistance from sales experts that have been selected to respond to the customer's requested assistance, at the location of the customer in the store. The present invention enables a drastic improvement of the shopping experience from “the customer has to go looking and wait for the right sales person” to “the right sales person goes looking for the customer anywhere in the store”. This effectively transforms “stressful waiting time” of customers in “relax and enjoy shopping moments”, while the customer is assured that the right expert will be joining him or her, in the proper order, as soon as the expert is available.

Embodiments of the present invention provide efficient deployment of the sales force. The allocation of the sales person to the customer is based on multiple criteria: required expertise, availability, proximity to the customer, previous interactions, and overall workload.

In further embodiments, the historical volumes of shopping assistance interactions are used to model and predict future staffing needs. Historical contact information is loaded and used to generate future staffing models that allow staffing according to anticipated needs. Embodiments of the present invention help predict the need for staffing and create work schedules for the sales force that match the expected needs.

Embodiments of the invention identify and recognize the retailer's best customers the moment each customer begins using the system in the store. The customer identity is then used to access a database of information relating to that customer including, for example, the customer's prior purchases, prior interaction with the shopping assistance service, etc. In addition, embodiments of the invention also accumulate highly valuable customer behavior information by recording each customer's movements through the store and adds this information to a database. These traffic patterns in the store are stored in a data warehouse and are analyzed in both real time and in historical context. This customer movement data assists the retailers to improve their merchandising effectiveness and product mix.

In further embodiments, analysis of customer movements throughout the store are used to optimize the store floorplan, e.g., dead zone removal, through analysis of customer flows and dwell times.

Among other things, the embodiments of the present invention provide a system for shopping assistance in a retail store including: (a) tags that are wirelessly connected to the system and provide a means to signal a request for assistance and to identify the position (track & trace) of customers in the store, (b) terminals that are optionally used by the customer to add information regarding the request for assistance, (c) kiosks where customers can pick-up the tags and use the shopping assistance system's terminals, (d) a central server that processes the customer requests, (e) mobile devices that provide a means to track & trace the position of the expert sales person, that are used by the sales staff to interact with the central server and to navigate to the next customer's location in the store.

Embodiments of the present invention use tags that are small, easy to carry, battery powered devices that provide a means for the customer to signal a request for assistance and to track & trace the position of a customer. Signaling a request can be done by (a) pushing the tag's button, or (b) holding the tag close to the terminal within the range of short range wireless communication (e.g., NFC). This type of communication can also be used as a means to (a) communicate with a sales person's mobile device to signal the start of a sales assistance intervention, (b) to communicate with a device at payment desk to link the customer's in-store route to the customer's identity that may be established at the desk (e.g., based on loyalty card info). In further embodiments, the tags' button can also be used for other purposes (e.g., distress signals). The tags can also include an indicator or small display to signal customer-specific events (e.g., the purchased products are ready at the payment desk) as well as further assistance information (e.g., an indication of the current queue length at the payment desk and/or the current estimated waiting time at the payment desk). In the case that a display is present, also advertising (possibly selected on the basis of said customer profile) may be visualized. In a further embodiment of the present invention the tag can be replaced by a mobile device of the customer, such as a smartphone that is running an app emulating the tag's functionality, including the ability to visualize assistance information and advertising. In yet another embodiment of the present invention the tag may be a mobile device provided by the store, such as a tablet or iPod Touch that is configured to function as tag, including the ability to visualize assistance information and advertising.

Embodiments of the present invention use terminals (e.g., tablet) as a means for the customer to optionally: (a) enter the nature of the request for assistance, (b) enter the product categories related to the request, (c) enter contact information (e.g., initials) and/or (d) enter the preferred sales person. Further, the terminals could contain a camera or a barcode reader. Said camera allows to capture an image of the customer's face, which can be used for: (a) recognizing returning customers, (b) forwarding the image to the sales person's mobile device to aid customer identification and (c) retrieving data related to the recognized customer and forwarding this data to the sales person's mobile device to aid shopping assistance. Said barcode reader may allow identifying the customer by reading a barcode, e.g. the barcode present on the customer's loyalty card. Terminals are also a means to welcome the customer and to inform him about: (a) special offers, (b) the location of the sales person's in the store (by showing a picture of the person on top of his location on the shop's floorplan).

Embodiments of the present invention make use of kiosks that include one or more terminals and offer a collection of tags for customers to pick-up. Kiosks are placed at the entrance points of the store, or are strategically distributed over the store.

In an embodiment of the present invention, the request for assistance may be triggered by the proximity of a tag for a prolonged time span near a product display. The product display may comprise a short-range wireless communication (e.g. NFC) means, preferably an emitter, which is able to detect the presence of a tag comprising a short-range wireless communication (e.g. NFC) means, preferably a passive element. When the tag is closer than a predetermined distance, for example the range of the short-range wireless communication or another predetermined distance, for a continuous or accumulated predetermined amount of time, to the product display communication means, the product display emits a signal to request the assistance of a sales person. This is advantageous to detect when a customer is attracted by a particular product and is studying the product for a prolonged amount of time. A sales person can then approach the customer and ask whether the customer has any questions or if the sales person can be of any help to the customer. The customer may forget to push the button or touch area with button functionality or may be in doubt whether to ask for assistance. A signal issued due to such a stationary tag may be given the same priority as an actively triggered tag (button or touch area with button functionality push) or may be given a lower priority, preferably a lower priority. The sales person can then approach said customer when no other requests for assistance are pending, for example. Note that in this embodiment, the short-range wireless communication means plays the double role of establishing the proximity of a sales person's mobile device as well as the proximity of a product display.

In an embodiment, if the tag remains stationary for a prolonged amount of time at a location which does not correspond to a designated storage area (e.g. a kiosk), i.e. the tag's location does not change more than a predetermined distance during at least a continuous predetermined amount of time, a signal to request the assistance of a sales person may also be issued. A tag may be lost or displaced, or a customer may have fallen or be in need of medical assistance. A signal issued due to such a stationary tag may be given the same priority as an actively triggered tag (button or touch area with button functionality push) or may be given a lower priority, preferably a lower priority. The sales person can then approach said tag and/or customer when no other requests for assistance are pending, for example. Alternatively, after closing hours, the tags outside of designated storage areas may be tracked by their trace & track functionality.

Also, embodiments of the present invention provide a central server with one or more of the following functions but is not limited to the following functions: (a) indoor localization, (b) real-time sales force management, (c) order preparation, (d) customer recognition and analysis, (e) sales force analysis, planning and optimization, (f) store analysis and optimization.

Real-time sales force management includes maintaining for each sales person a queue of customer requests that are sorted according to the time of entry. As soon as a customer request is made, the server allocates the request to one of the sales persons by pushing the request on the queue associated with that sales person, based on several criteria: (a) actual queue length, (b) availability of the associated sales person, (c) match between the nature of the request and the expertise of the sales person to which the queue is associated, (d) the preference of the customer for a sales person, if that was entered at the terminal, (e) if the customer is recognized as a returning customer, preference could be given to the sales person that handled prior sales interactions, (f) proximity of the sales person to the customer. The server forwards the queue that is associated with a specific sales person to the mobile device of that sales person. The sales person uses the mobile device to track & trace the customer whose request is on top of the queue (has the oldest time stamp) and to navigate to his or her actual location. By means of short range communication (e.g., NFC), an interaction between the customer's tag and the sales person's mobile device signals the start of an assistance intervention. At the completion of the intervention, the sales person pops the request from the queue, optionally sends an order preparation request to the store's warehouse, optionally adds notes of the intervention for future use, and proceeds with the next request on the queue. A sales person can also push the request to the queue of another sales person if assistance is required from another expert.

If the sales person requested an order preparation via his or her mobile device, the central server will forward the request to the warehouse. The customer can continue shopping till his or her tag indicates that the ordered products are available at the payment desk. As such, tedious waiting at the payment desk is turned into an opportunity for joyful shopping in the store

Customer recognition and analysis includes the identification of the customer based on data collected at the terminal (e.g., contact info, initials, image of the face, loyalty card), retrieving historical data of previous customer interactions (e.g., notes from previous interactions), analysis of that data (e.g., extract potential product interests from previous dwell times in the store), and forwarding the analysis to the mobile device of the sales person to aid the customer assistance.

Sales force analysis and optimization includes the analysis of the historical workload and the response time of the individual sales persons and aggregation per expertise, for the purpose of (a) predicting the future workload and matching the composition and size of the sales force to match the expected load, and (b) incentivizing the sales persons, e.g., by rewarding top performers with a bonus.

Store analysis and optimization includes the analysis of customer trajectories and dwell times to detect hotspots and dead zones and to identify opportunities for store floorplan improvements.

Embodiments of the present invention make use of mobile devices that are associated with individual sales persons. Sales persons use the mobile devices to: (a) communicate with the central server for customer request queue management and retrieving customer related data, (b) retrieve the customer's location in the store and navigate to their actual location, (c) signal start of intervention via short range communication with the customer's tag, (d) signal the completion of the intervention, or forwarding the request to a colleague, (e) submit notes about the intervention for future reference, (f) send a request to prepare an order, and (f) track & trace their actual position in the store.

In an embodiment of the present invention, the system may comprise at least one biometric measuring device. Each biometric measuring device may be coupled to at least one of the terminals. A customer interested in a product which depends on specific biometrical features of the customer can then, upon requesting help for a particular product via the terminal, provide additional biometric information via the terminal and the biometric measuring device. A sales person can then immediately provide the requested product compatible with the customer's biometry at the first interaction with the customer. This is advantageous as most requests for fitting a particular item of clothing, such as, for example, a hat, gloves, shoes, pants, a shirt, and the like, are initiated by establishing the corresponding biometric information for the sales person to subsequently fetch the product. Within this document, biometric information can be any measurable physiological quantity, such as, for example, foot size, foot width, foot stance, foot supporting points, foot pressure map, body length, head circumference, neck circumference, chest circumference, waist circumference, thigh circumference, calf circumference, leg length, torso length, arm length, shoulder width, wrist circumference, hip circumference, weight, position of eyes relative to nose, hand size, finger length, and the like.

This Overview is provided to introduce a selection of concepts in a simplified form that are further described below in the Detailed Description. This Overview is not intended to be used to limit the scope of the claimed subject matter.

### OVERVIEW OF THE DRAWINGS

The present invention may be more readily described by reference to the accompanying drawings in which:

FIG. 1 is a block diagram of an example embodiment of a system for assisting a customer in a retail store.

FIG. 2 is a drawing of an example embodiment of a Tag.

FIG. 3 is a drawing of an example embodiment of a Terminal.

FIG. 4 is a drawing of the functional component of the Central Server.

FIG. 5 is a drawing of the functional flow chart of an example embodiment of the customer assistance system.

### FURTHER DESCRIPTION OF THE INVENTION

This disclosure will now more fully describe some embodiments with reference to the accompanying drawings, in which only some of the possible embodiments are shown. Other aspects may, however, be embodied in many different forms and should not be construed as limited to the embodiments set forth herein. Rather, these embodiments are provided so that this disclosure will be thorough and complete and will fully convey the scope of the possible embodiments to those skilled in the art.

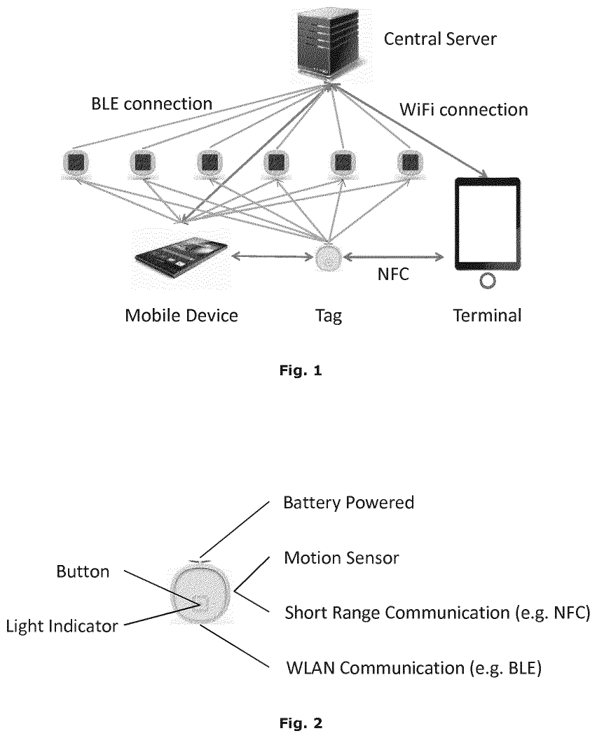

FIG. 1 shows the block diagram of an example embodiment of the present invention. For indoor positioning purposes the embodiment makes use of beacons that communicate with Tags and Mobile Devices on the one hand and with the Central Server on the other.

The beacons are distributed over the store and perform received signal strength indication (RSSI) measurements of Bluetooth Low Energy signals that are exchanged between the beacons and Tags & Mobile Devices. These RSSI measurements are forwarded to the Central Server that combines this information with motion data from the Tags & Mobile Devices and floorplan information to calculate the most likely location of the Tags & Mobile Devices. WiFi links between the Central Server and the Mobile Devices and the Terminals are used for exchanging information. NFC communication between the Tag and the Terminal is used to enter a request for assistance. NFC communication between the Tag and a Mobile Device is used to signal the start of an assistance intervention.

FIG. 2 shows an example embodiment of a Tag, such as BlooLoc's yooBee Tag, that is used in the present invention. Tags are small, easy to carry devices that include: (a) battery to power the device. Given the short time of usage, the battery can be made extremely small; (b) motion sensors and compass to estimate the movement and orientation of the customer as he or she moves throughout the store; (c) BLE communication to send pings to the beacons for RSSI measurements as a means to support indoor localization; (d) NFC communication to interact with Mobile Devices and/or Terminals; (e) NFC communication with gates at the store's exit points to signal the customer that he or she has forgotten to return the Tag; (f) NFC communication at the payment desk to link the Tags trajectory to the customer's identity; (g) button as a means for the customer to signal events to the Central Server (e.g., request for assistance or distress); and (h) light indicator as means for the Central Servicer to signal events or assistance information to the customer (e.g., order is ready at the payment desk, possibly with indication of the current number of customers in queue and/or the current estimated waiting time at the payment desk).

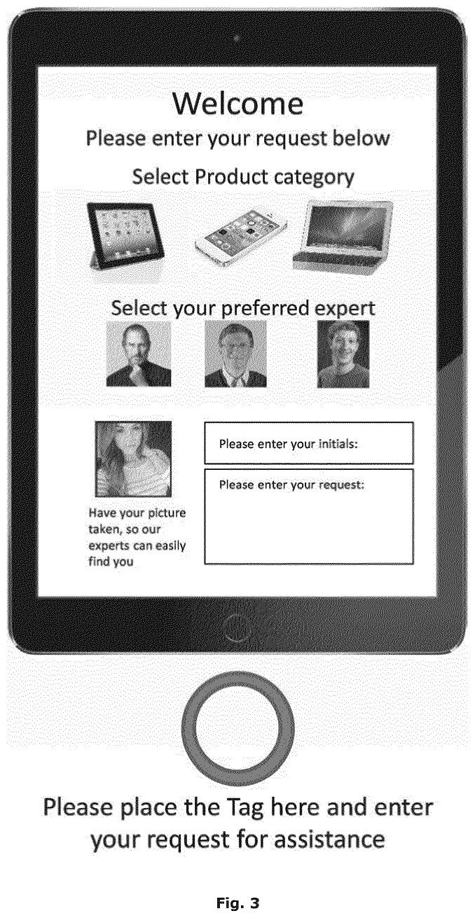

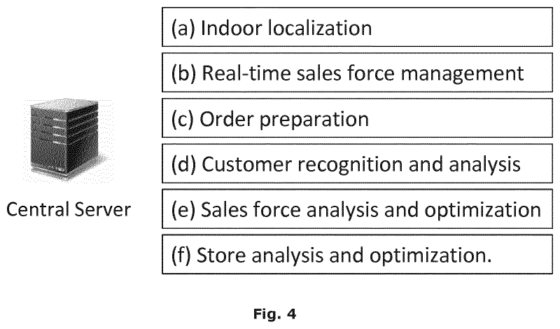

FIG. 3 shows an example embodiment of a Terminal that is used in the present invention. It includes an NFC reader to interact with a Tag and an input/output device, such as an iPad that runs an application as a means for a customer to specify a request for assistance, and more specifically: (a) Select a product category related to his request; (b) Select a preferred expert; (c) Have his or her picture taken, such that the sales expert can more easily identify the customer in the store and the Central Center can use face recognition to establish the customer's identity and retrieve & store relevant data of the identified customer; (d) Enter initials, such that the sales expert can properly address the customer in the shop; and (e) Enter text related to the request for assistance.

An embodiment of the Mobile Device that is used in the present invention is any state-of-the-art smartphone that includes: (a) Bluetooth Low Energy; (b) motion sensors, such as acceleration, rotation and compass; (c) NFC to communication with the Tags; (d) WiFi to communicate with the Central Server; (e) runs an indoor localization app, such as BlooLoc's Mobile SDK, and (f) runs a sales force management app to interact with the Central Server.

FIG. 4 shows an embodiment of the Central Server that is used in the present invention. The Central Server is a computer that is physically located in the store, or in a remote datacenter (Cloud) and communicates via a network with the Mobile Devices and Terminals and via a gateway, such as BlooLoc's yooBee BaseStation, to the beacons. The Central Server offers the following functions: (a) indoor localization, such as BlooLoc's Cloud SDK; (b) Real-time sales force management, which a queue management system; (c) Order preparation, which notifies the warehouse that an order needs to be prepared and forwarded to the payment desk; (d) Customer recognition and analysis, which uses face recognition to identify returning customers and to link product interests that are extracted from the customer's trajectories throughout the store; (e) Sales force analysis and optimization, which includes the analysis of the historical workload and the response time of the individual sales persons and aggregation per expertise, for the purpose of predicting the future workload and matching the composition and size of the sales force to match the expected load, and incentivizing the sales persons, e.g., by rewarding top performers with a bonus; (f) Store analysis and optimization which includes the analysis of customer trajectories and dwell times to detect dead zones and to identify opportunities for store floorplan improvements

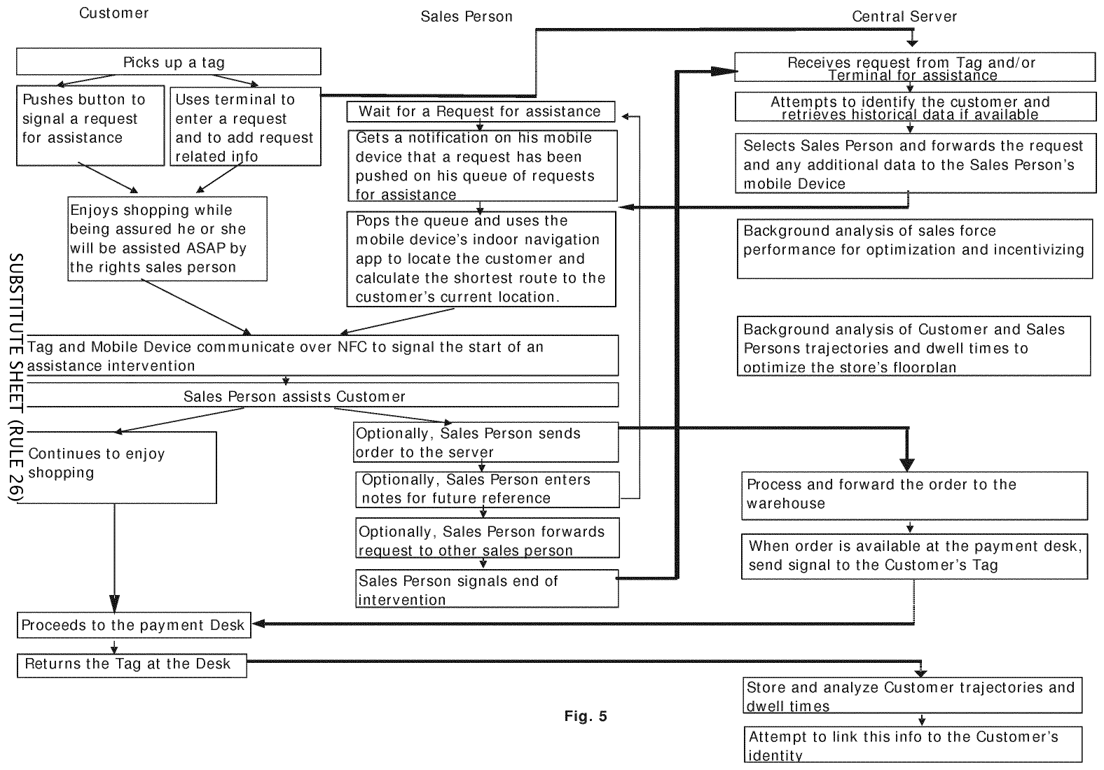

FIG. 5 shows the functional flow chart of an example embodiment of the present invention. The chart is self-explanatory.

### Example

This example serves the purpose to illustrate the present invention and should under no circumstances be interpreted as limiting.

A running store sells both running shoes and other apparel such as clothes. A customer enters the store and takes a tag. Before proceeding further into the store, the customer holds the tag in front of a terminal. The terminal polls the gender of the customer and whether running shoes are desired. The customer indicates that he or she would like running shoes. The terminal asks the customer to take place on a foot measurement plate (a biometric measuring device) barefooted. The foot measurement plate measures the shoe size, foot width, weight, and/or foot pronation of the customer. Subsequently, the customer browses the apparel in the store.

Once a sales person indicates on his smartphone that he is available, the sales person receives information regarding the request for running shoes. The sales person can preselect pairs of running shoes compatible with the customer's gender and one or more of the customer's shoe size, foot width, weight, and foot pronation. The sales person places the shoe boxes of suitable pairs in a fitting area provided with seats and fetches the customer. The smartphone of the sales person detects the proximity of the customer's tag. The customer thereby does not have to wait for the sales person to fetch compatible running shoes. The customer tries the preselected shoes in the fitting area and selects a pair. The sales person takes the customer's credit card and the selected pair of running shoes to a checkout counter to bill the purchase, while the customer can continue to browse the apparel. When the purchase is ready for billing, the customer receives a signal on the tag and proceeds to the checkout counter to sign the bill. The customer brings a jacket he or she would like to buy. The jacket is easily added to the bill based on the pre-entered credit card information. The customer signs the bill, returns the tag, and leaves the store with the two purchases.

1. A method for assisting customers, comprising the steps of:
(a) providing a customer with a tag for localizing said customer;
(b) obtaining localization information about said tag while said customer moves through the store;
(c) attributing a ranking to a customer, if a request for assistance is received from said customer, whereby said ranking is indicative of the priority of the customer in a group of customers requesting assistance;
(d) obtaining localization information about a sales person via a mobile device of said sales person;
(e) if said customer is entitled to assistance based on said ranking and if said sales person is available for lending assistance, allocating said sales person to said customer;
(f) notifying said sales person via his mobile device that a customer needs assistance and providing information about the location of said customer in the store to said sales person via his mobile device;
(g) obtaining assistance information that the sales person has started assisting the customer, wherein said assistance information is obtained on the basis of an interaction between the mobile device and the tag, and
(h) obtaining end-of-assistance information when the sales person has ended assisting the customer.

2. A method according to claim 1, wherein said interaction between the mobile device and the tag comprises determining a relative distance between the mobile device and the tag and comparing said relative distance with a predefined maximum distance to determine that the mobile device and the tag have been in close proximity, preferably wherein said mobile device and said tag interact via near field communication (NFC) and/or Bluetooth, preferably NFC.

3. A method according to claim 1, wherein said tag is one of the following:
an electronic device with means for localization and transmitting data, optionally comprising a button or touch area with button functionality as a signaling means to signal requests of the customer;
an application (“app”) installed on the mobile device of the customer with means for localization, transmitting data and signaling;
a mobile device provided by the store with means for localization, transmitting data and signaling;

4. A method according to claim 1, wherein said localization information about the tag and/or said localization information about said mobile device of the sales person is obtained via a real-time localization system, preferably based on Bluetooth signals being sent and/or received by said tag and/or said mobile device, and preferably wherein the real-time localization system comprises a plurality of beacons distributed across the store, preferably each of said beacons configured for sending and/or receiving Bluetooth signals.

5. A method according to claim 1, wherein said request for assistance is given via said tag.

6. A method according to claim 1, comprising the step of identifying the customer and optionally retrieving data regarding previous shopping behavior of said customer.

7. A method according to claim 1, comprising the step of providing the customer with assistance information regarding his ranking, the number of customers in queue and the expected waiting time, as well as advertising relating to said retrieved data regarding previous shopping behavior of said customer.

8. A method according to claim 1, wherein attributing of said ranking to a customer is performed taking into account any or any combination of the following:
the time of the request;
previous shopping behavior of the customer;
localization information of the customer such as a route of the customer through the store from the time of the request;
number of previous requests,
preferably whereby said ranking is based solely on the time of the request, thereby helping the customer on a first-come, first-served basis.

9. A method according to claim 1, comprising the step of receiving a shopping order from said customer through the mobile device of the sales person, said shopping order comprising identification information from the customer and/or the tag of the customer, and optionally preparing said shopping order for the customer to pick up at a payment desk, preferably said method comprising the step of preparing said shopping order for the customer to pick up at a payment desk, whereby a ready-signal signal is sent to the tag when the shopping order has been prepared.

10. A method according to claim 1, wherein the request for assistance is accompanied by biometric information of the customer.

11. A method according to claim 1, wherein said request for assistance may be triggered by the tag remaining within a predetermined distance of a product display for at least a predetermined amount of time.

12. A method according to claim 1, wherein said request for assistance may be triggered by the displacement of the tag during a predetermined amount of time being smaller than a predetermined distance.

13. A method for supporting a sales person via a mobile device, comprising the steps of:
(1) transmitting localization signals allowing localization of the sales person, preferably allowing localization of a mobile device of the sales person, within a store;
(2) transmitting an availability signal, indicating that the sales person is available to help a customer which is next in line;
(3) receiving customer localization information on the mobile device, indicating a location of the customer next in line and/or a route, preferably a shortest route, towards said customer next in line, and optionally receiving additional customer information;
(4) transmitting assistance information signaling that the sales person has started assisting the customer;
(5) transmitting end-of-assistance information signaling that the sales person has completed providing assistance to the customer,
wherein the assistance information signaling that the sales person has started assisting the customer is obtained on the basis of an interaction between the mobile device and a tag of said customer.

14. A method for obtaining assistance in a store, comprising the steps of:
(i) obtaining a tag;
(ii) transmitting localization information via said tag while being in and/or moving through the store;
(iii) transmitting a request for assistance via said tag;
(iv) interacting via said tag with a mobile device of a sales person responding to said request for assistance, thereby signaling that the sales person has started assisting the customer;
(v) optionally receiving and/or transmitting end-of-assistance information signaling that the sales person has completed providing assistance to the customer.

15. A system for assisting customers in accordance with a method according to claim 1, comprising:
a server computer, preferably having a server processor, tangible, non-transitory server memory, and server programming on the server memory instructing the server processor;
a tag for a customer, preferably a plurality of tags, one for each customer, said tag preferably comprising at least one button that can be pushed by the user for transmitting a request, and preferably said tag further having a tag processor, a wireless network interface, a battery or equivalent power source, a tangible, non-transitory tag memory, and tag programming on the tag memory instructing the tag processor;
a mobile device for a sales person, preferably a plurality of mobile devices, one for each sales person, said mobile device preferably having a mobile device processor, a mobile device display, a wireless network interface, a tangible, non-transitory mobile device memory, and mobile device programming on the mobile device memory instructing the mobile device processor;
wherein the tag is configured to allow localization of said tag within said store and wherein the mobile device is configured to allow localization of said tag within said store;
wherein the server computer is configured to obtain localization information about said tag while said customer moves through the store with said tag, and localization information about said mobile device;
wherein the tag is configured to transmit a request for assistance to said server computer, preferably by pressing a button on said tag;
wherein the server computer is configured to receive a request for assistance from the tag, and is further configured to attribute a ranking to said customer;
wherein the server computer is configured to obtain availability information of said sales person;
wherein the server computer is configured to allocate said customer to said sales person based on ranking of said request of said customer and availability of said sales person;
wherein the server computer is configured to notify said sales person via his mobile device that a customer needs assistance providing information about the location of said customer in the store to said sales person via his mobile device, and whereby said mobile device of the sales person is configured to receive the notification and location information of the customer;
wherein the mobile device and/or the tag are configured to transmit information to the server computer notifying that said sales person has started assisting said customer and wherein the server computer is configured to receive information from the sales person via said mobile device and/or from the customer via the tag, notifying that said sales person has started assisting said customer;
wherein the mobile device and/or the tag are configured to transmit information to the server computer notifying that said sales person has ended assisting said customer and wherein the server computer is configured to receive information from the sales person via said mobile device and/or from the customer via the tag, notifying that said sales person has ended assisting said customer,
wherein said tag and said mobile device are configured to interact with each other to signal when the sales person has started assisting the customer, preferably said interaction comprising a determination of the relative distance between the tag and the mobile device.

16. A system according to claim 15, comprising a terminal for said customer to provide additional information regarding the request for assistance, said terminal able to identify said tag of said customer, said terminal configured to send information related to said tag identification and said additional information to said server computer.

17. A system according to claim 16, comprising at least one biometric measuring device to measure biometric information of said customer upon providing said additional information, the system configured to send said biometric information from said biometric measuring device to said server computer, preferably said biometric measuring device in communication with said terminal and the system configured to send said biometric information from said biometric measuring device to said terminal and from said terminal to said server computer.

18. A system according to claim 15, wherein the system comprises a plurality of beacons for localizing said tag within said store, said plurality of beacons configured for signal exchange with said tag, preferably Bluetooth signal exchange, wherein the system is configured for one of the following:
emitting a signal from said tag and receiving said signal by at least one of said plurality of beacons, preferably receiving said signal by at least two of said plurality of beacons, more preferably receiving said signal by at least three of said plurality of beacons, said plurality of beacons configured for sending data related to said received signal to said server computer for determining the position of said tag within said store; and
emitting a signal from each of said plurality of beacons and receiving at least one of said signals by said tag, preferably receiving at least two of said signals by said tag, more preferably receiving at least three of said signals by said tag, said tag configured for sending data related to said received signals to said server computer for determining the position of said tag within said store.

19-21. (canceled)
